(19) United States
(12) Patent Application Publication
(10) Pub. No.: US 2026/0335169 A1
(43) Pub. Date: Oct. 29, 2026

(54) AMBULATION DEVICE

(71) Applicant: BOARD OF REGENTS OF THE UNIVERSITY OF NEBRASKA, Lincoln, NE (US)

(72) Inventors: Jason M. Johanning, Omaha, NE (US); Sara Myers, Ashland, NE (US); Carl Nelson, Lincoln, NE (US); Zach McWilliams, Elkhorn, NE (US)

(73) Assignee: BOARD OF REGENTS OF THE UNIVERSITY OF NEBRASKA, Lincoln, NE (US)

(21) Appl. No.: 19/657,540

(22) Filed: Apr. 24, 2026

Related U.S. Application Data
(60) Provisional application No. 63/795,934, filed on Apr. 28, 2025.

(51) Int. Cl. A61H 3/00

(52) U.S. Cl. CPC A61H 3/008; A61H 2201/0123; A61H 2201/0161; A61H 2201/1652

(57) ABSTRACT

An ambulation support device may include a support frame comprising: a first rail, a second rail; and a top frame element configured to join a first end of the first rail and a first end of the second rail via one or more corner hinges. The device may include one or more carrier assemblies supporting the support frame comprising: one or more carrier assemblies comprising: support elements configured to contact a ground surface at a first end, a first carriage pivotably coupled to a second end of the one or more support elements and slidably coupled to the first rail, one or more linkage members pivotably coupled to an intermediate portion of one or more of the support elements, a second carriage pivotably coupled to a second end of one or more of the linkage members and coupled to the first rail.

### CROSS-REFERENCE TO RELATED APPLICATION

The present application claims the benefit under 35 U.S.C. § 119(e) of U.S. Provisional Application Ser. No. 63/795,934, filed Apr. 28, 2025, which is incorporated herein by reference in the entirety.

### BACKGROUND

Patients recovering from surgery and other mobility-limiting conditions often require early and repeated ambulation to promote rehabilitation, restore functional gait, and reduce complications associated with prolonged immobility. However, current approaches to post-surgical ambulation and outpatient rehabilitation can present significant shortcomings, including logistical barriers such as scheduling and transportation, financial cost, low patient motivation, fear of re-injury, and inadequate knowledge of proper technique. Although effective rehabilitation is frequently provided in outpatient clinics, delays of days to weeks in accessing care may cause patients to miss a critical recovery window. Further, many existing technologies intended to support safe ambulation are primarily designed for hospital or clinic settings and tend to be bulky, heavy, non-portable, expensive, and often require assistance from a second person to operate, making them ill-suited for use in a patient's residence. Accordingly, there is a need for an ambulation support device suitable for at-home use that facilitates safe post-surgical ambulation for fall-risk populations, while being lightweight, portable, and easy for a single person to set up and store.

### SUMMARY

In one aspect, an ambulation support device for supporting a patient and movable from a deployed configuration to a collapsed configuration is disclosed. In one or more embodiments, the ambulation support device includes: a support frame configured to couple to a safety harness, the support frame including: a first rail; a second rail; and a top frame element configured to join a first end of the first rail and a first end of second rail via one or more corner hinges, wherein the support frame is configured to accommodate a mediolateral width of the patient between the first rail and the second rail. In one or more embodiments, the ambulation support device includes one or more carrier assemblies configured to support and elevate the support frame above a ground surface. In one or more embodiments, one or more of the carrier assemblies includes support elements configured to contact a ground surface at a first end, a first carriage pivotably coupled to a second end of one or more support elements and slidably coupled to the first rail, one or more linkage members pivotably coupled to an intermediate portion of one or more of the support elements, and a second carriage pivotably coupled to a second end of one or more of the one or more linkage members and coupled to a first rail at a position proximate to a second end of the first rail relative to the first carriage.

In another aspect, an ambulation support device for supporting a patient and movable from a deployed configuration to a stored configuration is disclosed. In one or more embodiments, the ambulation support device includes a support frame configured to couple to a patient harness and oriented in a longitudinal plane. In one or more embodiments, the support frame includes a first vertical support, a second vertical support; and a top support element configured to join a first end of the first vertical support and a first end of second vertical support, wherein the support frame is configured to accommodate a mediolateral width of the patient between the first vertical support and the second vertical support. In one or more embodiments, the ambulation support device includes a mounting assembly configured to couple the support frame to a wall structure. In one or more embodiments, the mounting assembly includes a hinged arm that includes a coupler configured to couple the mounting assembly to the support frame, a clamp configured to clamp the mounting assembly to the wall structure, and a hinge positioned between the coupler and the clamp, wherein the hinge defines a pivot axis about which the support frame pivots relative to the wall structure from the deployed configuration to the stored configuration.

In another aspect, an ambulation support device for supporting a patient and movable from a deployed configuration to a collapsed configuration, the ambulation support device is disclosed. In one or more embodiments, the ambulation support device includes a support frame configured to couple to a patient harness and oriented in a longitudinal plane, the support frame including: a first rail; a second rail; and a top frame element configured to join a first end of the first rail and a first end of the second rail via one or more corner hinges, wherein the top frame element includes: a first portion including a first rail end, a first hinge end, and a first top surface, wherein the first rail end is coupled to the first rail; a second portion including a second rail end, a second hinge end, and a second top surface wherein the second rail end is coupled to the second rail; a top frame hinge configured to couple the first hinge end to the second hinge end; and a lock positioned proximate to the top frame hinge and configured to lock the first hinge end to the second hinge end, whereupon a release of the lock, the top frame element is configured to pivot at the top frame hinge, and the first portion is configured to articulate relative to the first rail via a corner hinge of the one or more corner hinges. In embodiments, the ambulation support device includes a first carrier assembly; and a second carrier assembly, wherein the first carrier assembly and the second carrier assembly are oriented in a transverse plane relative to the support frame and configured to support and elevate the support frame above a ground surface.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and, together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1A is a perspective view of an ambulation support device in a deployed configuration, in accordance with one or more embodiments of the disclosure.

FIG. 1B is a close-up front view of a top section of the support frame.

FIG. 1C illustrates a perspective close-up view of a first carriage slidably coupled to the first rail, in accordance with one or more embodiments of the disclosure.

FIG. 1D illustrates a perspective close-up view of a second carriage slidably coupled to the first rail, in accordance with one or more embodiments of the disclosure.

FIG. 1E illustrates a perspective view of a collapsed ambulation support device, in accordance with one or more embodiments of the disclosure.

FIG. 1F illustrates a close-up side view of a top portion of the ambulation support device in the collapsed configuration, in accordance with one or more embodiments of the disclosure.

FIG. 2A is a perspective view of an ambulation support device coupled to a wall structure in a deployed configuration, in accordance with one or more embodiments of the disclosure.

FIG. 2B is a perspective view of an ambulation support device coupled to the wall structure in a stored configuration, in accordance with one or more embodiments of the disclosure.

FIG. 2C is a through-doorway perspective view of an ambulation support device coupled to the wall structure in the deployed configuration, in accordance with one or more embodiments of the disclosure.

FIG. 3A illustrates a schematic of an ambulation support device fully deployed in a deployed configuration, in accordance with one or more embodiments of the disclosure.

FIG. 3B illustrates a schematic of an ambulation support device in a collapsed configuration, in accordance with one or more embodiments of the disclosure.

FIGS. 4A-4I illustrate graphs depicting analyses of the folded and unfolded configurations of the ambulation support device for varying lengths, in accordance with one or more embodiments of the disclosure.

FIG. 5 illustrates a graph depicting the height difference between the folded and unfolded states of the ambulation support device, in accordance with one or more embodiments of the disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the present disclosure.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Finally, as used herein, any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Ambulation support devices for a patient are disclosed. Used with or without a safety harness worn by the patient and attached to the ambulation support device, the device allows a person to stand upright and place some or all of their weight on their legs, preventing the patient from falling to the ground. The ambulation support devices are compatible with rehabilitation equipment, such as a treadmill. The ambulation support devices are lightweight and foldable or collapsible, making them suitable for at-home rehabilitation. In an embodiment, the ambulation support device is movable from a deployed configuration to a collapsed configuration. In another embodiment, the ambulation support device is pivotable from a deployed configuration to a stored configuration. These ambulation support devices are lightweight, portable, and foldable/collapsible, and may be set up and taken down by one person.

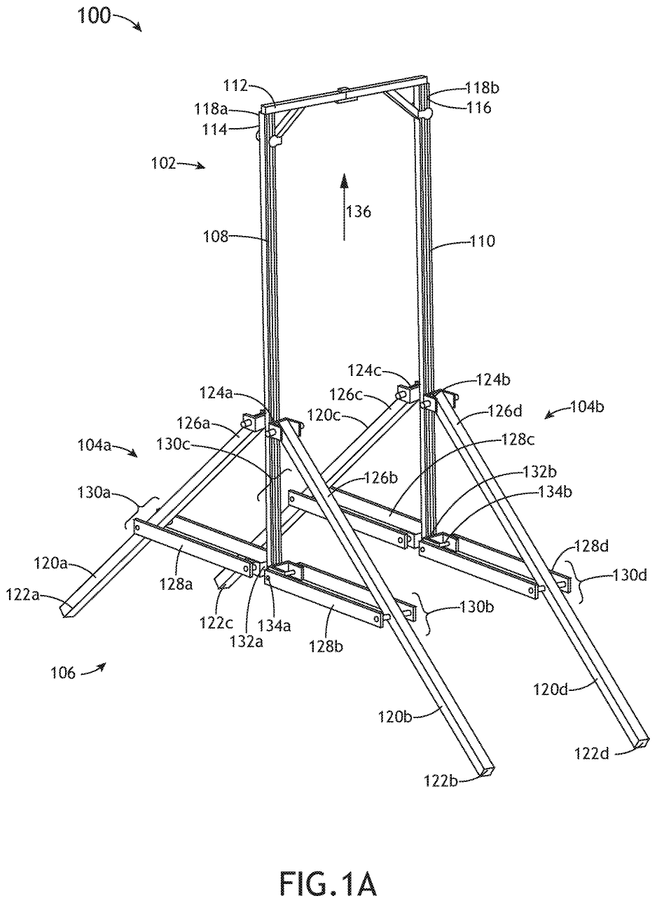

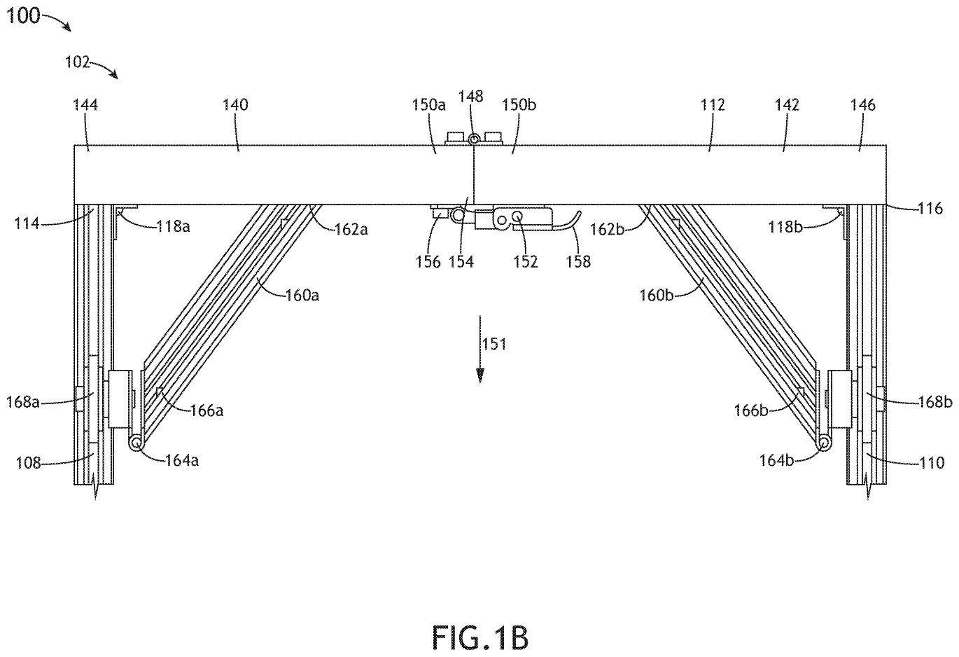

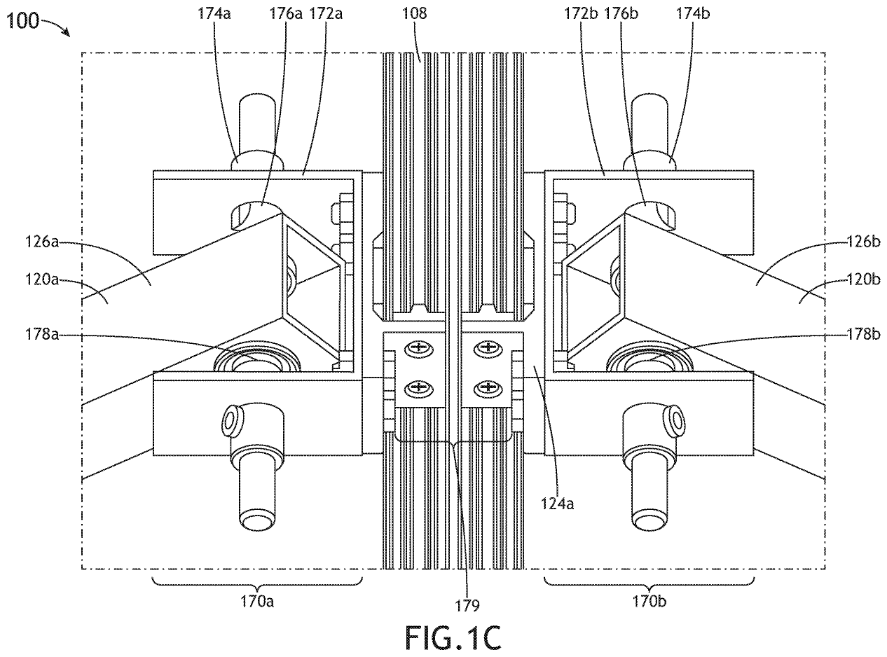

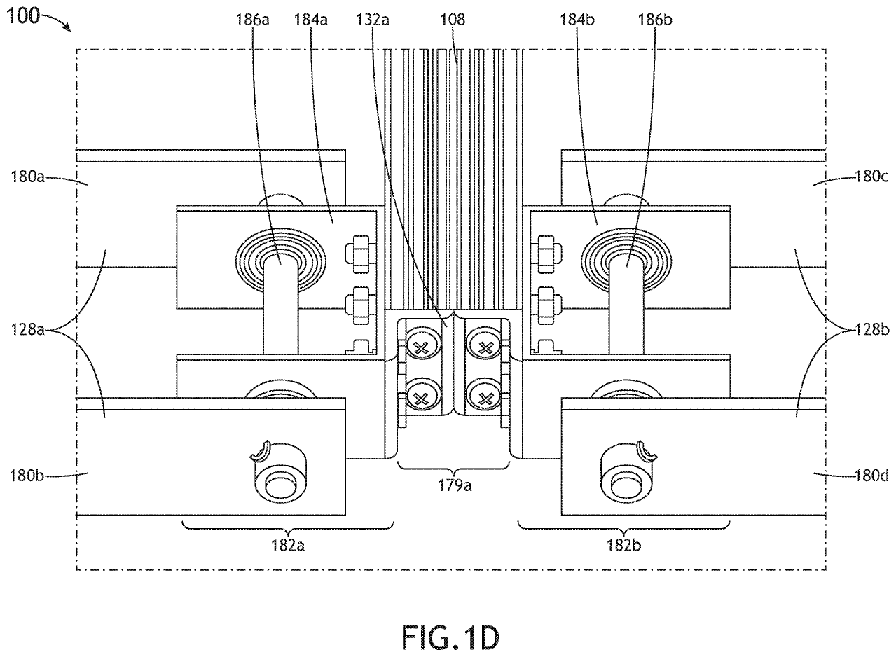

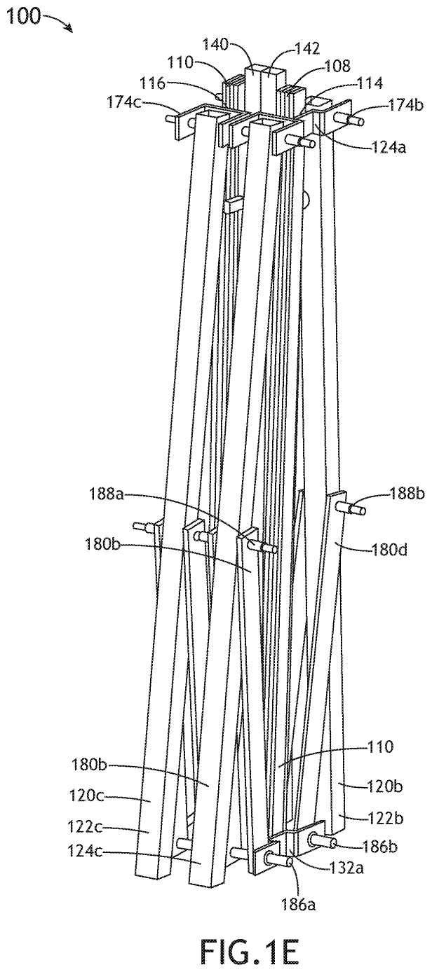

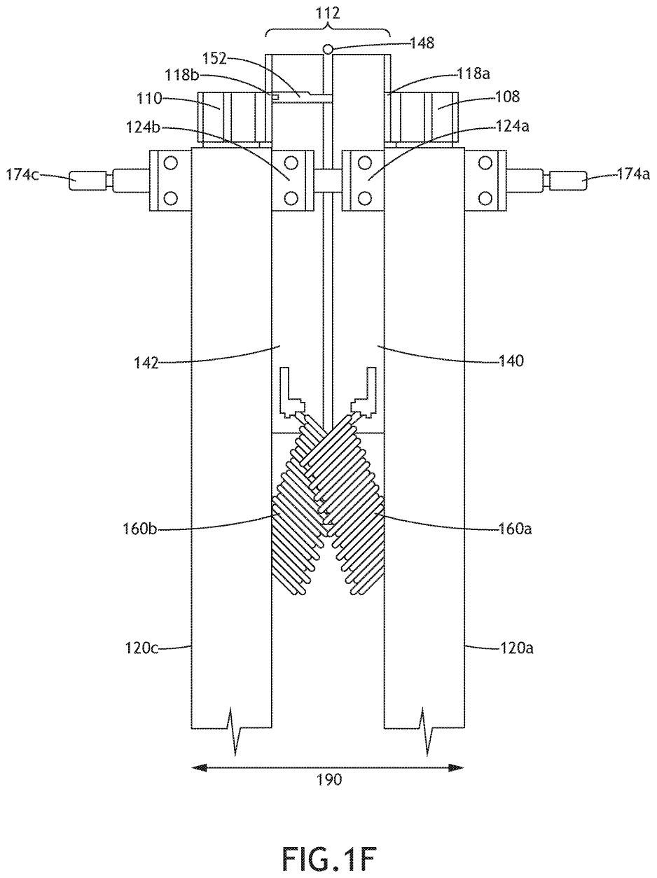

FIG. 1A is a perspective view of an ambulation support device 100 in a deployed configuration, in accordance with one or more embodiments of the disclosure. The ambulation support device 100 is a standalone device that does not need to be anchored to a wall or door. The ambulation support device 100 is also collapsible, as described herein.

In embodiments, the ambulation support device 100 includes a support frame 102 that is couplable to a safety harness, and one or more carrier assemblies 104a, 104b, that support the support frame 102 in an upright position and elevate the support frame 102 above a ground surface 106. The support frame 102 may be oriented along a longitudinal plane, with the one or more carrier assemblies 104a, 104b oriented in a transverse plane relative to the support frame 102. The ambulation support device 100 may be self-supporting on the ground surface (e.g., requiring no anchoring to the ground surface or to other structures, such as a door frame).

The support frame 102 may include a first rail 108, a second rail 110, and a top frame element 112 that is configured to join a first end 114 of the first rail 108 and a first end 116 of the second rail via corner hinges 118a, 118b. The support frame 102 may be configured to accommodate a mediolateral width of the patient between the first rail 108 and the second rail 110. For example, a patient wearing a safety harness may have the safety harness coupled to the top frame element 112 and have a treadmill positioned between the carrier assemblies 104a, 104b. This arrangement may allow a patient to walk on the treadmill with the patient's weight partially or wholly supported by the support frame 102, with the first rail 108 and the second rail 110 available for the patient to grab if needed. The carrier assemblies 104a, 104b may each include a pair of opposing support elements 120a, 120b, 120c, 120d configured to contact the ground surface 106 at a first end.

In embodiments, the ambulation support device 100 includes one or more first carriages 124a, 124b pivotably coupled to second ends 126a, 126b, 126c, 126d of one or more of the support elements 120a-d and slidably coupled to a respective rail 108, 110. The ambulation support device 100 may further include one or more linkage members 128a, 128b, 128c, 128d (e.g., double bar linkage members) pivotably coupled to an intermediate portion 130a, 130b, 130c, 130d of a respective support member 120a-d. The ambulation support device 100 may further include one or more second carriages 132a, 132b, pivotably coupled to respective linkage members 128a-d and slidably or fixedly coupled to respective rails 108, 110. The one or more second carriages may be disposed at a position proximate to a respective second end 134a, 134b of a respective rail 108, 110 that the first carriage 124a, 124b.

In embodiments, the one or more first carriages 124a, 124b are configured to slide along a respective rail 108, 110 as the ambulation support device 100 moves from a deployed configuration to a collapsed configuration for storage. For example, as the first carriages 124a, 124b are translated in a first direction 136 toward the first end 114, 116 of the rails 108, 110, the second ends 122a, 122b of the support elements 120a, 120b, and the second ends 122c, 122d of the support elements 120c, 120d move toward each other via a pivoting of respective linkage members 128a-128d, which shortens the overall length of the carrier assemblies as well as the overall height of the ambulation support device 100. The second carriages 124a, 124b may also translate in the first direction, further shortening the overall height of the ambulation support device 100, depending on the design. In this manner, the collapsing action of the one or more carrier assemblies 104a, 104b resembles a symmetric double-slider crank mechanism. For example, the rails 108, 110, support elements 120a-f and carriages 124a, 124b, 132a, 132b may define a double-slider crank mechanism. In some embodiments, the second carriages 124a, 124b are secured tightly to the rail 108, 110, and do not slide freely. The overall height of the ambulation support device 100 in the collapsed configuration may be approximately equal to, or substantially equal to, the height of the first rail 108. For example, the height of the first rail 108 may be 90% or greater than the overall height of the of the ambulation support device 100 in the collapsed configuration.

In embodiments, the height of the ambulation support device 100 in the deployed configuration may be considerably greater than the height of the ambulation support device 100 in the collapsed configuration. For example, the height of the ambulation support device 100 in the deployed configuration may be approximately 78 inches, while the height of the ambulation support device 100 in the collapsed configuration may be approximately 62 inches. Further, the width of the ambulation support device 100 in the deployed configuration may be approximately 50 inches, while the width of the ambulation support device 100 in the collapsed configuration may be approximately 12 inches. The ambulation support device 100 may have a weight of approximately 40 pounds.

FIG. 1B is a close-up front view of a top section of the support frame 102, in accordance with one or more embodiments of the disclosure. The length of the top frame element 112 is not shown to scale. The support frame 102 may be collapsible along the top frame element 112, thereby reducing the overall width of the ambulation support device 100.

In embodiments, the top frame element 112 includes a first portion 140 and a second portion 142. The first portion 140 may include a first rail end 144 configured to pivotably couple to the first rail 108, and the second portion 142 may include a second rail end 146 configured to pivotably couple to the second rail 110.

In embodiments, the top frame element 112 includes a top frame hinge 148 configured to couple a first hinge end 150a of the first portion 140 to a second hinge end 150b of the second portion 142. The top frame hinge 148 is aligned such that when the top frame element 112 is in an unlocked position, and a downward force 151 is applied to the top frame hinge 148, the first portion 140 and the second portion 142 both pivot at the top frame hinge 148 and respective corner hinges 118a, 118b, reducing the width of the support frame 102.

In embodiments, the top frame element 112 comprises a lock 152 proximate to the top frame hinge 148 configured to lock the first hinge end 150a to the second hinge end 150b and prevent the top frame hinge 148 from pivoting. For example, the lock 152 may be permanently affixed to the second portion 142 and have a collar 154 that releasably couples to an anchor 156 on the first portion 140, locking the first portion 140 and second portion 142 together while preventing the top frame hinge 148 from pivoting. The lock 152 may further include a release 158 that, when pulled, allows the collar 154 to release from the anchor 156, freeing the top frame hinge 148.

In embodiments, the support frame 102 may include one or more corner braces 160a, 160b removably couplable to respective portions 140, 142 of the top frame element 112 and respective rails 108, 110. The corner braces 160a, 160b may be configured to add structural support to the support frame 102 while also being able to move out of position during a movement of the ambulation support device 100 from the deployed configuration to the collapsed configuration. For example, the corner braces 160a, 160b may be releasably attachable to their respective portions 140, 142 of the top frame element 112. For example, the first ends 162a, 162b may include attachment elements that fit into the underside of their respective portions 140, 142. In another example, the corner braces 160a, 160b may include brace hinges 164a, 164b at or near second ends 166a, 166b of the corner braces 160a, 160b that allow the corner braces 160a, 160b to decouple and swing away from the respective portions 140, 142 when the first ends 162a, 162b have been released from the respective portions 140, 142.

In embodiments, the corner braces 160a, 160b include slide elements 168a, 168b (e.g., slide wheels) that couple the brace hinges 164a, 164b to the respective rail 108, 110. The slide elements 168a, 168b may be slidably coupled to the rails 108, 110. For example, once the lock 152 and the first ends of 162a, 162b of the corner braces 160a, 160b have been released, the corner braces 160a, 160b may pivot downward, and the slide elements 168a, 168b may slide down their respective rail 108, 110, making room for the portion 140 and the second portion 142 to swing around and lie next to their respective rail 108, 110. The slide elements 168a, 168b may occupy and/or slide upon a different rail surface than the first carriage 124a, 124b, preventing collisions between the slide elements and the first carriages 124a, 124b.

FIG. 1C illustrates a perspective close-up view of one of the first carriages 124a slidably coupled to the first rail 108, in accordance with one or more embodiments of the disclosure. In embodiments, a pair of support elements 120a, 120b couple to the first carriage 124a via pivot joints 170a, 170b. For example, the pivot joints 170a, 170b may include brackets 172a, 172b that attach to the first carriage 124a and support pivot pins 174a, 174b via bracket apertures 176a, 176b. The pivot pins 174a, 174b pass through apertures 178a, 178b near the second ends 126a, 126b of the support elements 120a, 120b, completing the pivot joints 170a, 170b.

In embodiments, the pivot pins 174a, 174b are couplable to accessories of the ambulation support device 100. For example, the pivot pins 174a, 174b may be extended well past the bracket apertures 176a, 176b and configured to couple to armrests that help stabilize the patient. In another example, the pivot pins 174a, 174b may be configured for providing a mounting surface for medical equipment, such as a monitor (e.g., a heart monitor).

In embodiments, the rails 108, 110 and the carriages 124a, 124b, 132a, 132b are collectively formed as prismatic joints. A prismatic joint may be a one-degree-of-freedom joint. The prismatic joint between the rails 108, 110, and the carriages 124a, 124b, 132a, 132b may permit the carriages 124a, 124b, 132a, 132b to axially translate relative to the rails 108, 110, and vice versa, but may permit no other relative translation or relative rotation therebetween. The prismatic joint may include any suitable prismatic joint, such as, but not limited to, a polygonal joint (e.g., a square joint, a hexagonal joint), a stadium joint, a D-joint, a keyed joint, a floating spline joint, a dovetail slide, a linear bearing, or the like.

In embodiments, the first carriages 124a, 124b and/or the second carriages 132a, 132b include a tightening assembly 179 that secures the first carriages 124a, 124b and/or the second carriages 132a, 132b to a point on a respective rail 108, 110 For example, the tightening assembly 179 may include screws or other device that place pressure on the rail 108, preventing the first carriages 124a, 124b and/or the second carriages 132a, 132b from slipping while the patient is using the ambulation support device 100.

FIG. 1D illustrates a perspective close-up view of a second carriage 132a slidably coupled to the first rail 108, in accordance with one or more embodiments of the disclosure. In embodiments, the bars 180a, 180b, 180c, 180d of the linkage members 128a, 128b couple to the second carriage 132a via pivot joints 182a, 182b. For example, the pivot joints 182a, 182b may include brackets 184a, 184b that attach to the second carriage 132a and support pivot pins 186a, 186b that pass through both the brackets 184a, 184b and the bars 180a, 180b, 180c, 180d. The second carriage 132a may further include a tightening assembly 179a. The tightening assembly 179a may be configured to secure the second carriage 132a, 132b to the rail 108, 110. The tightening assembly 179a may further be configured to inhibit translation of the second carriage 132a, 132b along the first rail 108, 110.

FIG. 1E illustrates a perspective view of a collapsed ambulation support device 100, in accordance with one or more embodiments of the disclosure. Sliding the first carriage 124a toward the first ends 114, 116 of the rails 108, 110 causes the second end 122a-d of the support elements 122a-d to move toward the rails 108, 110, shortening the lengths of the carrier assemblies 104a, 104b. The second carriage 132a remains at or near the second ends of the rails 108, 110, and joint pins 188a, 188b that connect the bars 180b, 180d to the support elements 120a, 120b are moved adjacent to a middle portion of the rails 108, 110. The first portion 140 and second portion 142 of the top frame element 112 are shown collapsed and nestled together between the rails 108, 110.

FIG. 1F illustrates a close-up side view of a top portion of the ambulation support device 100 in the collapsed configuration, in accordance with one or more embodiments of the disclosure. The first carriages 124a, 124c have been translated toward the first ends of the rails 108, 110, with support elements 120a, 120c (e.g., with pivot pins 174a, 174c) nearly obscuring the rails 108, 110. The first portion 140 and the second portion 142 of the top frame element 112 are unlocked from the lock 152, are articulated via the corner hinges 118a, 118b and the top frame hinge 148, and are disposed laterally adjacent to each other and between the rails 108, 110. The corner braces 160a, 160b have released from the first portion 140 and the second portion 142, respectively, during the transition from the deployed configuration to the collapsed configuration, and hang downwards between the rails 108, 110. The collapsing of the first portion 140 and the second portion decreases the overall width 190 of the ambulation support device 100.

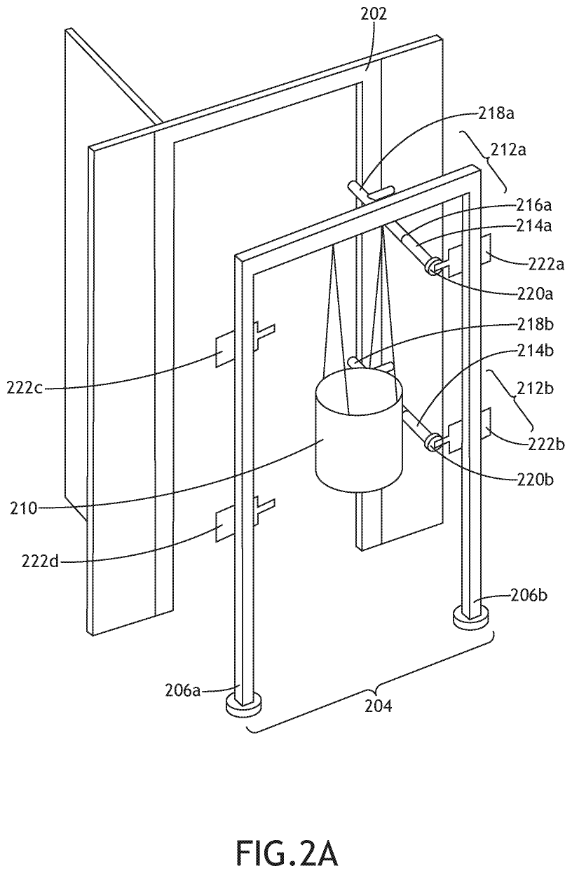

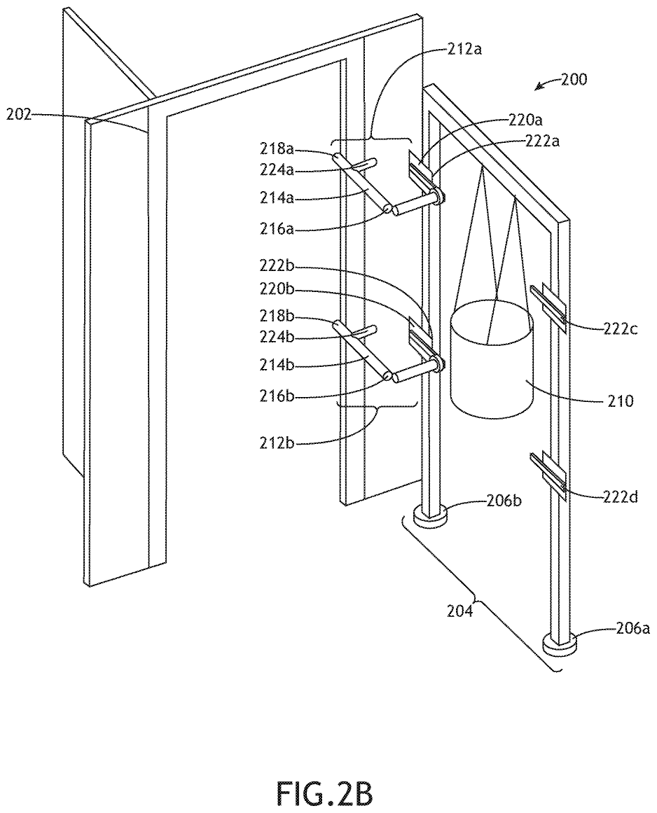

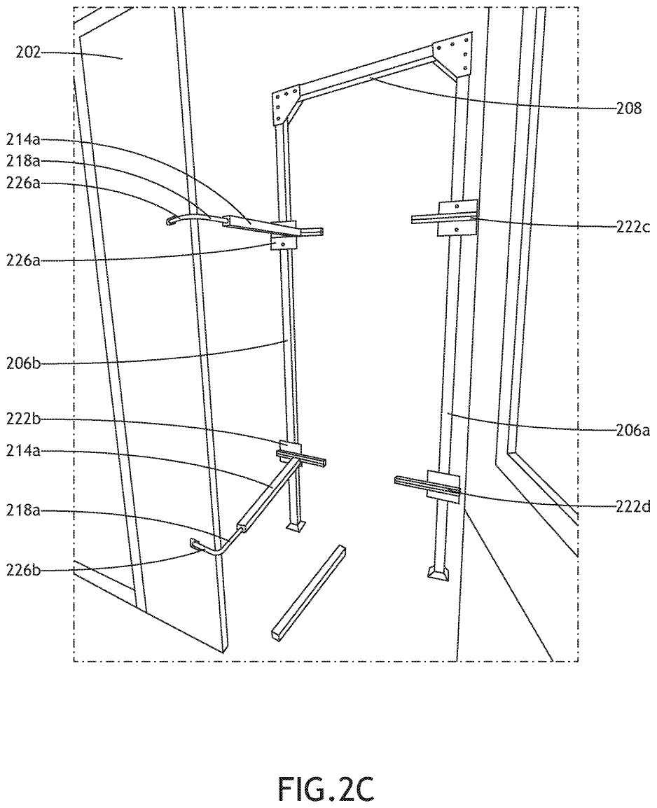

FIG. 2A is a perspective view of an ambulation support device 200 coupled to a wall structure 202 (e.g., a door frame) in a deployed configuration, in accordance with one or more embodiments of the disclosure. The ambulation support device 200 is configured to be coupled to a sturdy object that supports both the ambulation support device 200 and the patient. The ambulation support device 200 may be moved from the deployed configuration to a stored configuration, where the ambulation support device 200 can be pivoted away from the original deployment footprint. For example, the ambulation support device 200 may be deployed at a doorway during use, then pivoted away from the doorway to the stored configuration.

In embodiments, the ambulation support device 200 includes a support frame 204 that includes one or more vertical supports 206a, 206b (e.g., a first vertical support 206a and a second vertical support 206b), and a top support element 208 joining the vertical supports 206a, 206b. The support frame 204 may be configured to accommodate a mediolateral width of a patient between the first vertical support 206a and the second vertical support 206b. The top support element 208 and/or the vertical supports 206a, 206b may be configured to couple to and support a safety harness 210.

In embodiments, the ambulation support device 200 includes one or more mounting assemblies 212a, 212b that are couplable to the support frame 204 and the wall structure 202. The mounting assemblies 212a, 212b may include an arm 214a, 214b (e.g., a hinged arm that includes a hinge 216a, 216b). The arm 214a, 214b may include a clamp 218a, 218b that clamps the arm 214a, 214b to the wall structure 202. The arm 214a, 214b may include a coupler 220a, 220b that couples the arm 214a, 214b to the support frame 204. The support frame 204 may include one or more brackets 222a, 222b that attach to the couplers 220a, 220b. The support frame 204 may include additional brackets 222c, 222d that are also couplable to the support arms 214a, 214b, enabling the ambulation support device 200 to attach to the other side of the wall structure (alone, or in addition) if needed.

FIG. 2B is a perspective view of an ambulation support device 200 coupled to the wall structure 202 in a stored configuration, in accordance with one or more embodiments of the disclosure. To move from the deployed configuration to the stored configuration, the support frame 204 is pivoted upon one of the vertical supports 206a, 206b, so that the support frame 204 is positioned away from (e.g., approximately perpendicular to) the position of the support frame 204 in the deployed position. The arms 214a, 214b of the mounting assemblies 212a, 212b bend at the hinge 216a, 216b, allowing the support frame 204 to pivot while still attached to the wall structure 202. For example, the hinge 216a, 216b may define a pivot axis about which the support frame 204 pivots relative to the wall structure 202 from the deployed position to the stored position. FIG. 2B further illustrates an adjustable jaw 224a, 224b of the clamp 218a, 218b.

FIG. 2C is a through-doorway perspective view of an ambulation support device 200 coupled to the wall structure 202 in the deployed configuration, in accordance with one or more embodiments of the disclosure. In embodiments, the clamp 218a, 218b is configured to adjust to a depth of the wall structure 202, such as a depth of a door or a door frame. The clamp 218a, 218b may include a fixed jaw 226a, 226b that, along with the adjustable jaw 224a, 224b, can effectively clamp the mounting assembly 212a, 212b to the wall structure 202, stabilizing the support frame 204.

In embodiments, the ambulation support devices 100, 200 may include a safety harness 210. For example, the ambulation support devices 100, 200 may include a safety harness 210 that can support all, or nearly all, of the weight of a patient as they perform standing and walking tasks upon the ground or on a treadmill while the safety harness is coupled to the appropriate components upon the ambulation support devices 100, 200. The ambulation support devices 100, 200 may further include other components including, but not limited to, a treadmill, a storage container, and a sensor (e.g., a heart sensor).

### EXAMPLES

The following examples are provided to further describe and enable the subject matter disclosed herein and to illustrate representative implementations, experimental protocols, and/or performance results. Unless expressly stated otherwise, the examples are not intended to limit the scope of the appended claims or to define any particular embodiment as essential. Any terminology, headings, figure captions, references, or stylistic conventions appearing in such manuscript content are presented for convenience and readability and shall not be construed to narrow the meaning of any claim term unless the claim term is expressly defined herein.

### Example 1: Design of a Lightweight Ambulation Support for In-home Ambulation

Introduction

Recovery following surgery involves restoring bodily functions, managing pain, and addressing complications. While rest is often considered fundamental to this process, evidence increasingly supports the benefits of early ambulation—the act of moving or walking—as a more effective approach to recovery. For example, studies on early mobilization of patients who underwent hip or knee joint replacements demonstrated that initiating ambulation within 48 hours of admission reduced hospital stays by an average of 1.8 days compared to previous standards. Within the hospital setting, ambulation helps patients regain mobility and range of motion. However, this process rarely restores them to their pre-surgery state. Consequently, outpatient ambulation becomes essential for patients seeking to fully recover their mobility.

Current methods for outpatient ambulation have shortcomings. Outpatient physical therapy, which typically begins about one week after hospital discharge, misses the critical early window for optimal recovery and offers limited opportunities for ambulation. Additionally, logistical barriers such as transportation, scheduling conflicts, and costs further restrict patient access. In-home ambulation programs address some of these challenges but are often inconsistent and less effective due to factors such as low patient motivation, inadequate knowledge of proper techniques, and fear of re-injury. These limitations in outpatient and in-home ambulation methods result in insufficient therapy and a lack of comprehensive technological support, leading to decreased patient compliance. As a result, many patients fail to fully recover their pre-surgery mobility.

Ambulation technology is primarily designed for hospital settings, making it unsuitable for home use due to its specific design constraints. These devices provide necessary support but lack key features required for home environments. These devices are also neither compact nor easily storable, nor lightweight, and often require assistance from a second person for operation. Other devices may be capable of independent use by patients, shares the same limitations regarding size and folding functionality. Moreover, these devices are prohibitively expensive and typically accessible only to hospitals or specialized care facilities.

This highlights a significant gap in ambulation technology: the lack of devices that are practical for home use. For general exercise programs, patients are commonly provided with walkers and canes, or, in some cases, encouraged to walk independently. However, these mobility aids, while essential for balance, compromise the therapeutic benefits of upright exercise on the lower extremities. On the other hand, attempting ambulation without such aids increases the risk of falls and potential reinjury, presenting a conflict of objectives. Patients require the protective support of balance and weight-bearing aids while also needing the therapeutic advantages, such as musculoskeletal and cardiorespiratory benefits, gained from independent ambulation. This contradiction underscores the inadequacy of current in-home solutions for effective recovery. Accessible, safe, and effective ambulation is essential for post-surgical rehabilitation, yet existing methods and technologies fail to meet these critical needs.

This Example presents the design and development of a lightweight, foldable ambulation support device optimized for home rehabilitation. The device leverages a doorframe as its attachment point, ensuring it is compact, storable, and cost-effective compared to existing alternatives. A prototype was built using a hinged clamp mechanism that allows the device to swing away when not in use, addressing the need for easy setup by a single user. While the initial design offered key features such as full-body support and stability, limitations such as space constraints and attachment challenges prompted a second iteration. This revision explored solutions for improved functionality and adaptability, ultimately suggesting the potential for a free-standing design that meets all constraints.

### Materials and Methods

After assessing the current market for ambulation devices and identifying key limitations in the rehabilitation space, it became clear that the design needed to be lightweight, foldable, and easily reconfigurable for use in the home environment. To meet these requirements, a design that attaches to an existing home structure was chosen. A free-standing device, being bulkier and heavier, could have posed difficulties with storage and mobility. To identify an appropriate structure that complements the device's functionality, standard home layouts were examined, leading to the selection of a doorframe attachment point. Prior research has shown that doorframes can support the full weight of an average person, as demonstrated by doorframe pull-up bars. With the device's scope defined, the next step was to select a non-permanent attachment method for the doorframe. A hinged clamp mechanism was chosen, allowing the device to swing away from the doorway and stow against the wall when not in use, as depicted in FIGS. 2A-2B. This design eliminated the need for a second person for setup, ensured the device could be stored at home, was lightweight, and was more cost-effective than alternative devices.

After finalizing the design process, a physical prototype was built based on the model shown in FIG. 2C. The prototype exhibited key features such as full-body support, ease of storage, and stability to prevent tipping, but also revealed several unexpected challenges. These included interference with the ambulation space, difficulty attaching the device to the hinge side of the doorframe, and issues with the attachment arms' weight limiting movement due to downward pressure on the slides. In response, a second design iteration was developed to explore alternative solutions to address these new constraints. One key finding from this iteration was that integrating additional design concepts related to folding mechanisms could enable the creation of a free-standing device that meets all design requirements.

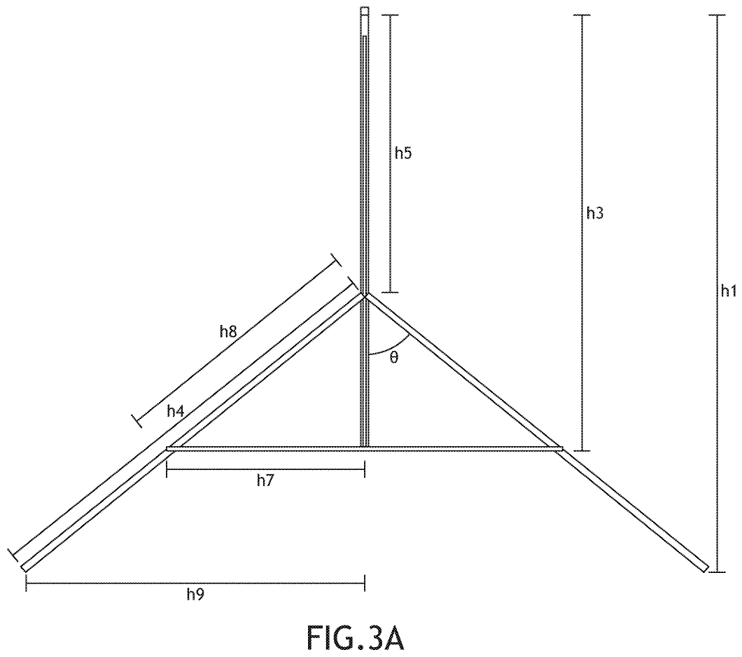

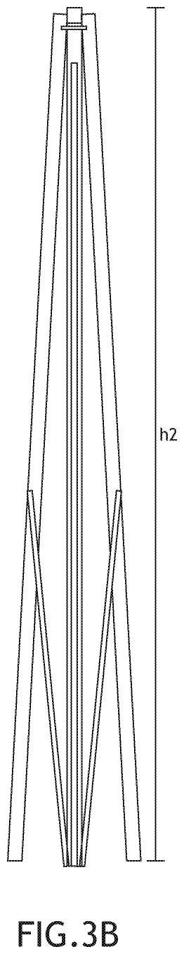

During the prototyping phase of the first design, the design team conducted interviews with 21 professionals experienced in post-surgical ambulation and rehabilitation. These interviews provided valuable insights into the key challenges faced in rehabilitation regimes, particularly those the device aims to address. One of the most significant findings was that motivation often acts as a major barrier to ambulation. This highlighted the need for the device to be easy to set up and store, reducing the likelihood of abandonment and ensuring sustained engagement with the rehabilitation process. As a result, the team placed a greater emphasis on the foldability of the device. To explore potential solutions, a review of 25 foldable devices and 10 body weight support devices was conducted, leading to the development of various mechanism designs to maximize foldability while maintaining structural integrity and body weight support. This effort resulted in the second prototype, which features a sagittal plane folding mechanism based on a symmetric double-slider crank system, reducing both height and width (FIGS. 3A-3B), as well as a simple hinge folding mechanism for the coronal plane (FIG. 1B). These mechanisms enable the device to transform into a compact, manageable assembly for easier storage when not in use.

To analyze the influence of design parameters on the foldability of the ambulation support device, the symmetric double-slider crank mechanism for sagittal-plane folding is modeled to establish mathematical relationships among key parameters within the given physical design constraints. The fully deployed state of the mechanism is illustrated in FIG. 3A, while the folded state is shown in FIG. 3B. All relevant lengths and angles are labeled in FIGS. 3A-3B.

The mechanism's shape change is constrained to a single plane, meaning the deployment volume depends solely on the height h₁ and the width h₉. The parameter h₁ is set as the mechanism height to ensure the device can support a person standing on a treadmill. The parameter h₉ is defined to ensure the base width provides sufficient stability, reducing the risk of tipping over during use. Considering standard room dimensions, the height and width of the mechanism are specified as h₁=78 inches and h₉=50 inches, respectively. In the mechanism, h₅ and h₇ are selected as the key parameters to define the overall layout. All other parameters are expressed in terms of these variables. The deployment angle is:

θ=arctan (h₉/(h₁−h₅)) (1)

The length of the vertical beam is:

h₃=h₅+(h₇/tan θ) (2).

The total length of the inclined beam is:

h₄=(h₁−h₅)/cos θ (3).

The length of the upper portion of the inclined beam is:

h₈=h₇/sin θ (4)

To analyze the length of the folded mechanism under different scenarios, the length of the folded mechanism, h₂, is divided into h_{2,upper}, and h_{2,lower}. Note that h₂≠h_{2,upper}+h_{2,lower}. These two separate parameters are defined as follows:

h_{2, upper}={h₃−h₇−h₈, h₃>h₇+h₈; 0, h₃≤h₇+h₈} (5)

h_{2, lower}={h₄−h₇−h₈, h₄>h₇+h₈; 0, h₃≤h₇+h₈}.

In the folded configuration, Eq. (5) accounts for the excess of h₃ over h₈ at the upper tip and h₄ over h₇ at the lower tip, as only the greater values contribute to the folded mechanism's length. By combining Eqs. (1) to (5), the length of the folded mechanism can be calculated as:

h₂=h₇+h₈+h₂, upper+h₂, lower

The variables h₅ and h₇ are optimized to maximize the height difference between the folded and unfolded states of the mechanism, expressed as h₁−h₂. The results of the optimization are shown in the Results section.

Two special scenarios are considered. The first scenario assumes that h₃ and h₈ align at the upper tip of the folded mechanism, while the second scenario assumes that h₄ and h₇ align at the lower tip. The key conditions for these scenarios are:

h₃=h₇+h₈ (7)

and

h₄=h₇+h₈ (8)

respectively. Under the first scenario, by substituting Eqs. (2) and (4) into (7), h7 can be calculated in terms of h5 as follows:

h₇=(h₅ sin θ)/(1+sin θ−cos θ) (9)

Under the second scenario, by substituting Eqs. (3) and (4) into (8), h7 can be calculated in terms of h5 as follows:

h₇=((h₁−h₅) tan θ)/(1+sin θ). (10)

Equations 1-10 provide guidance for determining the length and angles of the ambulation support device 100 to achieve efficient packing when moving the device from the deployed to the collapsed configuration. For example, and in embodiments, the ambulation support device 100 may be designed such that when the ambulation support device 100 is in the deployed configuration (h₁−h₅), an angle (θ) between a portion of the first rail 108 positioned below the first carriage 124a and a support element 120a coupled to the first carriage defines a deploy angle. A length of the first rail (h₁) may then be approximately equivalent to a sum of a length (h₅) of the first rail 108 above the first carriage 124a and a length (h₇) of a linkage member 128a divided by a tangent of the deploy angle.

Further, the ambulation support device 100 may be designed such that when the ambulation support device 100 is in the deployed position, a length of the support element (h₄) is approximately equivalent to a difference of the length (h₅) of the first rail above the first carriage 124a and the length (h₇) of the linkage member 128a divided by a cosine of the deploy angle.

### Results and Discussion

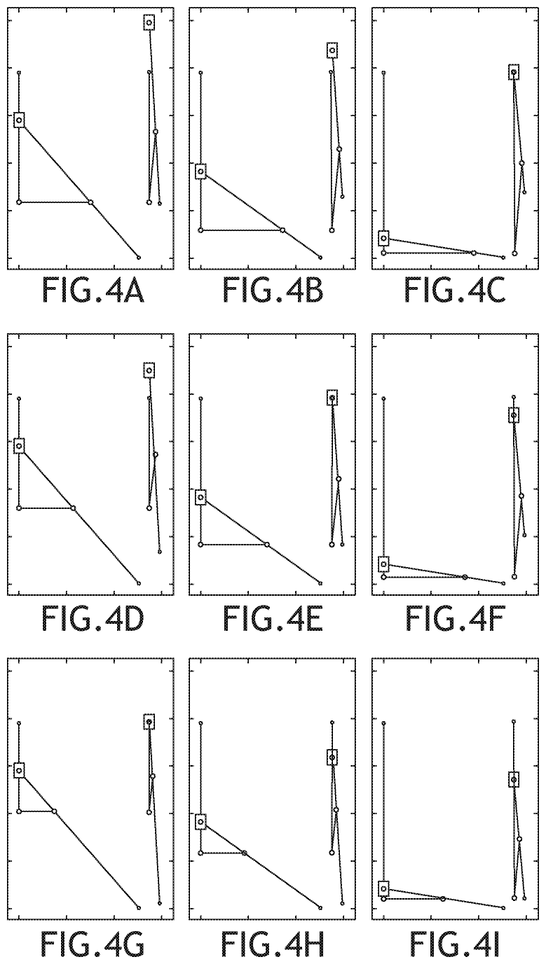

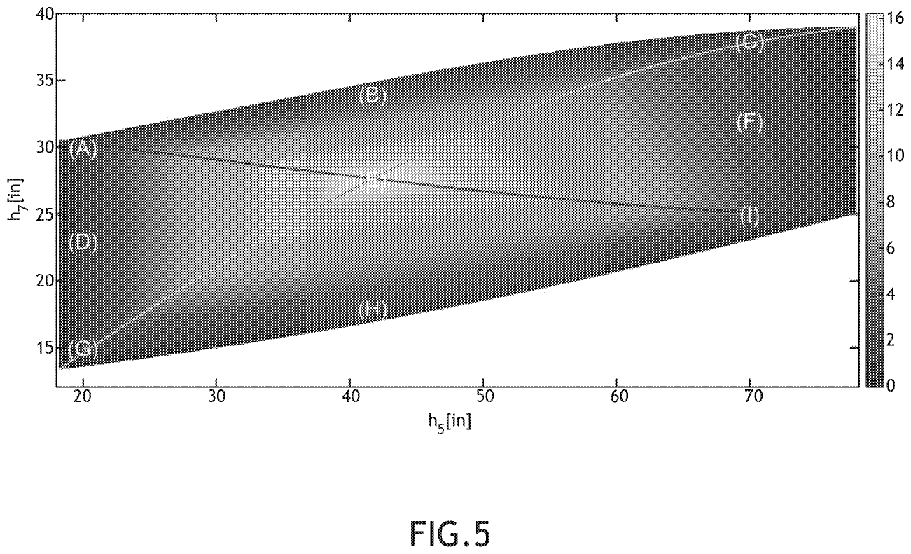

In this section, the design of the ambulation support mechanism is optimized by focusing on key length parameters defined through the double-slider crank mechanism. The calculations and simulations are performed using MATLAB. Different combinations of the variables h₅ and h₇ yield varying configurations of the ambulation support mechanism. The folded and unfolded configurations with different selections of these parameters are illustrated in FIGS. 4A-4I. A continuous range of h₅ and h₇ values is considered, and the height difference between the folded and unfolded configurations of the mechanism, represented as h₁−h₂, is calculated. The folded and unfolded configurations of the mechanism under varying clauses of h₅ and h₇ are shown. In FIGS. 4A, 4F, and 4G, h₅=20, with h₇=30, 23, and 15, respectively. In FIGS. 4B, 4E, and 4H, h₅=41.7249, with h₇=34, 27.6332, and 18, respectively. In FIGS. 4C, 4F, and 4I, h₅=70, with h₇=38, 34, and 25, respectively. The results are presented in FIG. 5. The solid blue curve represents the special case where h₃ and h₈ align at the upper tip of the folded mechanism, as discussed in Eq. (9), while the solid cyan curve represents the special case where h₄ and h₇ align at the lower tip, as discussed in Eq. (10). When both conditions are satisfied simultaneously, corresponding to point (E) in FIG. 5 and the configurations in FIG. 4E, the lengths and angles of various components are optimized to achieve the maximum height difference between the open and closed positions of the device while maintaining design constraints.

In FIG. 5, the height difference between the folded and unfolded states of the mechanism, represented as h₁−h₂, is shown across continuous ranges of h₅ and h₇. The shading bar on the right maps the colors to corresponding values of h₁−h₂. The white regions indicate parameter combinations where the folded mechanism exceeds the unfolded length, representing invalid cases. The solid blue curve shows the first special case discussed in Eq. (9), while the solid cyan curve corresponds to the second special case discussed in Eq. (10). Points labeled (A) through (I) correspond to the configurations in FIGS. 4A-4I. The lighter-shaded curves intersect at point (E), where the optimal result occurs.

The optimization of the ambulation support device revealed key relationships between design variables, particularly emphasizing the height difference between the open and closed positions. By identifying optimal conditions, including the lighter shaded curves in FIG. 5, the study ensures that the device's functionality and adaptability are maximized for home-based rehabilitation. These conditions balance stability, practicality, and ease of use, ensuring the device meets the needs of the intended user population.

The constraints on h₁ and h₉ further enhance the device's stability and usability, confirming its feasibility in various settings, particularly for outpatient rehabilitation. The systematic exploration of these relationships demonstrates that the chosen mechanism is both effective and adaptable to user requirements, providing a practical solution to current gaps in ambulation technology.

The herein-described subject matter sometimes illustrates different components contained within or connected with other components. It should be understood that the depicted architectures are merely exemplary, and that many other architectures can be implemented to achieve the same functionality. In a conceptual sense, any arrangement of components that achieves the same functionality is effectively “associated” with the desired functionality. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. An ambulation support device for supporting a patient and movable from a deployed configuration to a collapsed configuration, the ambulation support device comprising:
a support frame configured to couple to a safety harness and oriented in a longitudinal plane, the support frame comprising:
a first rail;
a second rail; and
a top frame element configured to join a first end of the first rail and a first end of the second rail via one or more corner hinges, wherein the support frame is configured to accommodate a mediolateral width of the patient between the first rail and the second rail; and
one or more carrier assemblies oriented in a transverse plane relative to the support frame and configured to support and elevate the support frame above a ground surface, wherein one of the one or more carrier assemblies is coupled to the first rail, one of the one or more carrier assemblies comprising:
support elements configured to contact a ground surface at a first end;
a first carriage pivotably coupled to a second end of one or more support elements and slidably coupled to the first rail;
one or more linkage members pivotably coupled to an intermediate portion of one or more of the support elements; and
a second carriage pivotably coupled to a second end of one or more of the one or more linkage members and coupled to a first rail at a position proximate to a second end of the first rail relative to the first carriage.

2. The ambulation support device of claim 1, wherein the top frame element comprises:
a first portion comprising a first rail end, a first hinge end, and a first top surface, wherein the first rail end is pivotably coupled to the first rail;
a second portion comprising a second rail end, a second hinge end, and a second top surface wherein the second rail end is pivotably coupled to the second rail;
a top frame hinge configured to couple the first hinge end to the second hinge end; and
a lock positioned proximate to the top frame hinge and configured to lock the first hinge end to the second hinge end and prevent the top frame hinge from pivoting, whereupon a release of the lock, the top frame element is configured to pivot at the top frame hinge, and the first portion is configured to articulate relative to the first rail via a corner hinge of the one or more corner hinges.

3. The ambulation support device of claim 2, wherein upon full translation of the first carriage to the first end of the first rail, an overall height of the ambulation support device is approximately equal to a height of the first rail.

4. The ambulation support device of claim 2, wherein translating the first carriage toward the first end of the first rail causes an overall height of the ambulation support device to decrease.

5. The ambulation support device of claim 2, wherein the support frame comprises a corner brace coupled to the first rail at a first brace end and removably couplable to the first portion of the top frame element at a second brace end, the corner brace comprising a hinge proximate to the first brace end and arranged such that upon a decoupling of the first brace end from the first portion of the top frame element, the first brace end articulates toward the first rail.

6. The ambulation support device of claim 5, wherein the corner brace is coupled to the first rail at a first brace end via a slide element configured to translate relative to the first rail.

7. The ambulation support device of claim 2, wherein the ambulation support device is self-supporting on the ground surface.

8. The ambulation support device of claim 2, wherein the second carriage comprises a tightening assembly configured to inhibit translation of the second carriage along the first rail.

9. The ambulation support device of claim 2, wherein the first rail, the first carriage, the second carriage, and the support elements define a double-slider crank mechanism.

10. The ambulation support device of claim 2, wherein in the deployed configuration, an angle between a portion of the first rail positioned below the first carriage and a support element coupled to the first carriage defines a deploy angle, wherein a length of the first rail is approximately equivalent to a sum of a length of the first rail above the first carriage and a length of a linkage member divided by a tangent of the deploy angle.

11. The ambulation support device of claim 10, wherein a length of the support element is approximately equivalent to a difference of the length of the first rail above the first carriage and the length of the linkage member divided by a cosine of the deploy angle.

12. An ambulation support device for supporting a patient and movable from a deployed configuration to a stored configuration, the ambulation support device comprising:
a support frame configured to couple to a patient harness and oriented in a longitudinal plane, the support frame comprising:
a first vertical support,
a second vertical support; and
a top support element configured to join a first end of the first vertical support and a first end of the second vertical support, wherein the support frame is configured to accommodate a mediolateral width of the patient between the first vertical support and the second vertical support; and
a mounting assembly configured to couple the support frame to a wall structure, the mounting assembly comprising:
a hinged arm comprising:
a coupler configured to couple the mounting assembly to the support frame;
a clamp configured to clamp the mounting assembly to the wall structure; and
a hinge positioned between the coupler and the clamp, wherein the hinge defines a pivot axis about which the support frame pivots relative to the wall structure from the deployed configuration to the stored configuration.

13. The ambulation support device of claim 12, wherein the clamp is configured to clamp to a frame depth of a door frame, wherein the clamp comprises a fixed jaw and an adjustable jaw opposite the fixed jaw.

14. An ambulation support device for supporting a patient and movable from a deployed configuration to a collapsed configuration, the ambulation support device comprising:
a support frame configured to couple to a patient harness and oriented in a longitudinal plane, the support frame comprising:
a first rail;
a second rail; and
a top frame element configured to join a first end of the first rail and a first end of the second rail via one or more corner hinges, wherein the support frame is configured to accommodate a mediolateral width of the patient between the first rail and the second rail; wherein the top frame element comprises:
a first portion comprising a first rail end, a first hinge end, and a first top surface, wherein the first rail end is coupled to the first rail;
a second portion comprising a second rail end, a second hinge end, and a second top surface wherein the second rail end is coupled to the second rail;
a top frame hinge configured to couple the first hinge end to the second hinge end; and
a lock positioned proximate to the top frame hinge and configured to lock the first hinge end to the second hinge end, whereupon a release of the lock, the top frame element is configured to pivot at the top frame hinge, and the first portion is configured to articulate relative to the first rail via a corner hinge of the one or more corner hinges;
a first carrier assembly; and
a second carrier assembly, wherein the first carrier assembly and the second carrier assembly are oriented in a transverse plane relative to the support frame and configured to support and elevate the support frame above a ground surface, wherein the first carrier assembly is coupled to the first rail, wherein the second carrier assembly is coupled to the second rail, each of the first carrier assembly and the second carrier assembly comprising:
a pair of opposing support elements each configured to contact a ground surface at a first end;
a first carriage pivotably coupled to a second end of each of the pair of support elements and slidably coupled to a respective rail;
a pair of linkage members pivotably each coupled at a first end to an intermediate portion of a respective support element of the pair of opposing support elements; and
a second carriage pivotably coupled to a second end of each of the pair of linkage members and coupled to a respective rail at a position proximate to a second end of the respective rail relative to the first carriage.

15. The ambulation support device of claim 14, wherein upon full translation of each first carriage to the first end of the first rail, an overall height of the ambulation support device is approximately equal to a height of the first rail.

16. The ambulation support device of claim 14, wherein translating each first carriage toward the first end of the first rail causes an overall height of the ambulation support device to decrease.

17. The ambulation support device of claim 14, wherein the support frame comprises a corner brace coupled to the first rail at a first brace end and removably couplable to the first portion of the top frame element at a second brace end, the corner brace comprising a hinge proximate to the first brace end and arranged such that upon a decoupling of the first brace end from the first portion of the top frame element, the first brace end articulates toward the first rail.

18. The ambulation support device of claim 17, wherein the corner brace is coupled to the first rail at a first brace end via a slide element configured to translate relative to the first rail.

19. The ambulation support device of claim 14, wherein the ambulation support device is self-supporting on the ground surface.

20. The ambulation support device of claim 14, wherein each second carriage comprises a tightening assembly configured to inhibit translation of the second carriage along its respective rail.
